(19) United States
(12) Patent Application Publication
(10) Pub. No.: US 2026/0203989 A1
(43) Pub. Date: Jul. 16, 2026

(54) METHOD, DEVICE, AND COMPUTER PROGRAM FOR FACILITATING THREE-DIMENSIONAL MEASUREMENTS IN A SKYBOX

(71) Applicant: Telefonaktiebolaget LM Ericsson (publ), Stockholm (SE)

(72) Inventors: Volodya GRANCHAROV, Solna (SE); Sigurdur SVERRISSON, Kungsängen (SE); Elijs DIMA, Upplands Väsby (SE)

(73) Assignee: Telefonaktiebolaget LM Ericsson (publ), Stockholm (SE)

(21) Appl. No.: 19/133,999

(22) PCT Filed: Dec. 1, 2022
(86) PCT No.: PCT/EP2022/084115

§ 371 Date: May 29, 2025

(51) Int. Cl. G06T 15/00

(52) U.S. Cl. CPC G06T 15/00; G06T 2215/12

(57) ABSTRACT

There is provided techniques for facilitating 3D measurements in a skybox image rendering environment. A method is performed by a controller. The method comprises obtaining an indication that a 2D panoramic image is rendered in the skybox image rendering environment of a reconstructed 3D environment. The method comprises deriving auxiliary visual information for the panoramic image from depth maps of the panoramic image. The auxiliary visual information identifies 3D measurable areas in the skybox image rendering environment. The method comprises imposing the auxiliary visual information on the panoramic image as rendered in the skybox image rendering environment.

### TECHNICAL FIELD

Embodiments presented herein relate to a method, a controller, a computer program, and a computer program product for facilitating three-dimensional (3D) measurements in a skybox image rendering environment.

### BACKGROUND

In general terms, in the process of 3D reconstruction, the scene geometry can be represented by a 3D point cloud. In this respect, a 3D point cloud, denoted Dl, can be regarded as an unstructured set of K points in the 3D space (with dimensions X, Y, Z)

$$Ω = {( {X}_{k} , {Y}_{k} , {Z}_{k} )}_{k = 1}^{K}$$

The 3D point cloud can be used to capture the scene geometry and scale, to thereby represent 3D structures from the physical world.

A 3D point cloud can be generated by means of passive (e.g., registering multiple two-dimensional(2D) images of the scene and estimating depth values by triangulation) or by active scanning (e.g., light detection and ranging (LIDAR), where the depth values are estimated by measuring the time-of-flight of emitted light).

Since the physical scene to be scanned could be large or have complex geometry, the scanning device is typically placed on a tripod where a scanning is performed. The scanning is then moved to a new location where a new scanning is performed. At each of these positions the scanning device spins around and performs a 360-degree scan of the environment. A scanning performed at one location is therefore referred to as a sweep. A sweep for a given location consists of a 3D point cloud generated from the given scanning location, the parameters for the given scanning location, and a set of 2D images collected at the given scanning location.

The point cloud could be explored by the user directly, using different types of software tools. However, it can be cumbersome for a user to navigate and perform measurements directly in a 3D point cloud. An alternative way of enabling navigation and measurements in a 3D reconstructed scene is to render a 2D panoramic image in a skybox image rendering environment based on the underlying 3D point cloud. In this approach the user is exposed to a panoramic image projected on the side of a cube (and hence the term skybox). In general terms, the source of a skybox can be any form of texture, including photographs, hand-drawn images, or pre-rendered 3D geometry. It is hereinafter assumed that the source of the skybox is a 3D point cloud, and that the 3D point cloud is projected as a panoramic image that is created and aligned in 6 directions, with viewing angles of 90 degrees (which covers the 6 faces of the cube). This can be achieved by cube mapping. In general terms, cube mapping is a technique to create pre-rendered panoramic sky images which are then rendered by a graphical engine as faces of a cube at practically infinite distance with the view point located in the center of the cube. One skybox is formed from a 2D panoramic image 110 obtained from the 3D point cloud of one sweep. In FIG. 1 is illustrated an example skybox image rendering environment composed of one skybox 100 (FIG. 1(a)), where one individual image I_{n,s}={I_{n,-90}, I_{n,0}, I_{n,+90}, I_{n,360}, I_{n,up}, I_{n,down}} of a 2D panoramic image 110 (FIG. 1(b)) is rendered on each side of the skybox 100.

Navigation in the 3D reconstructed scene is then enabled by letting the user move from one cube to another, which corresponds to jump from one sweep to another. Further, measurements are enabled by using a correspondence between the image pixels and the corresponding 3D points in the 3D point cloud. In this way the user can perform measurements in the scene by clicking on pixels, but where the actual dimensions, or distances, are calculated based on the underlying 3D point cloud. That is, the actual measurements are made on the 3D point cloud (i.e., between points in 3D space), for which depth information is required.

One issue with existing techniques for 3D measurement in a skybox image rendering environment is that it is not always possible to perform accurate measurement. This is due to that the depth maps are incomplete. One reason for the depth maps to be incomplete is that, during the scanning process, the scanning device failed to receive any reflected light for some parts of the environment. Missing depth information does not allow distance to be accurately calculated in the 3D space.

One way to mitigate this issue is for the user to, by means of the 2D panoramic image, inspect the projection of the captured 3D scene on the 2D image plane. However, if the user selects beginning and/or end point of the measurement as image pixels that do not have a corresponding depth value, the measuring function will not be able to return any meaningful value.

Hence, there is still a need for improved 3D measurement in a skybox image rendering environment.

### SUMMARY

An object of embodiments herein is to enable 3D measurement to be made in a skybox mage rendering environment without suffering from the above issues.

According to a first aspect there is presented a method for facilitating 3D measurements in a skybox image rendering environment. The method is performed by a controller. The method comprises obtaining an indication that a 2D panoramic image is rendered in the skybox image rendering environment of a reconstructed 3D environment. The method comprises deriving auxiliary visual information for the panoramic image from depth maps of the panoramic image. The auxiliary visual information identifies 3D measurable areas in the skybox image rendering environment. The method comprises imposing the auxiliary visual information on the panoramic image as rendered in the skybox image rendering environment.

According to a second aspect there is presented a controller for facilitating 3D measurements in a skybox image rendering environment. The controller comprises processing circuitry. The processing circuitry is configured to cause the controller to obtain an indication that a 2D panoramic image is rendered in the skybox image rendering environment of a reconstructed 3D environment. The processing circuitry is configured to cause the controller to derive auxiliary visual information for the panoramic image from depth maps of the panoramic image. The auxiliary visual information identifies 3D measurable areas in the skybox image rendering environment. The processing circuitry is configured to cause the controller to impose the auxiliary visual information on the panoramic image as rendered in the skybox image rendering environment.

According to a third aspect there is presented a controller for facilitating 3D measurements in a skybox image rendering environment. The controller comprises an obtain module obtain configured to obtain an indication that a 2D panoramic image is rendered in the skybox image rendering environment of a reconstructed 3D environment. The controller comprises a derive module obtain configured to derive auxiliary visual information for the panoramic image from depth maps of the panoramic image. The auxiliary visual information identifies 3D measurable areas in the skybox image rendering environment. The controller comprises an impose module obtain configured to impose the auxiliary visual information on the panoramic image as rendered in the skybox image rendering environment.

According to a fourth aspect there is presented a computer program for facilitating 3D measurements in a skybox image rendering environment. The computer program comprises computer code which, when run on processing circuitry of a, causes the controller to perform actions. One action comprises the controller to obtain an indication that a 2D panoramic image is rendered in the skybox image rendering environment of a reconstructed 3D environment. One action comprises the controller to derive auxiliary visual information for the panoramic image from depth maps of the panoramic image. The auxiliary visual information identifies 3D measurable areas in the skybox image rendering environment. One action comprises the controller to impose the auxiliary visual information on the panoramic image as rendered in the skybox image rendering environment.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable more accurate 3D measurement to be made a in skybox image rendering environment.

Advantageously, the improved accurate 3D measurements are achieved at the same time as the amount of information, transferred between the entity storing the point 3D clouds and the entity performing the measurements is reduced.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a skybox image rendering environment and a panoramic image according to an example;

FIG. 2 schematically illustrates a system according to an embodiment;

FIG. 3 is a flowchart of methods according to embodiments;

FIG. 4 schematically illustrates example images according to embodiments;

FIGS. 5 and 6 schematically illustrate a 3D measurement process according to embodiments;

FIG. 7 is a schematic diagram showing functional units of a controller according to an embodiment;

FIG. 8 is a schematic diagram showing functional modules of a controller according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved 3D measurement in a skybox image rendering environment.

The embodiments disclosed herein therefore relate to techniques for facilitating 3D measurements in a skybox image rendering environment 100. In order to obtain such techniques there is provided a controller, a method performed by the controller, a computer program product comprising code, for example in the form of a computer program, that when run on a controller, causes the controller to perform the method.

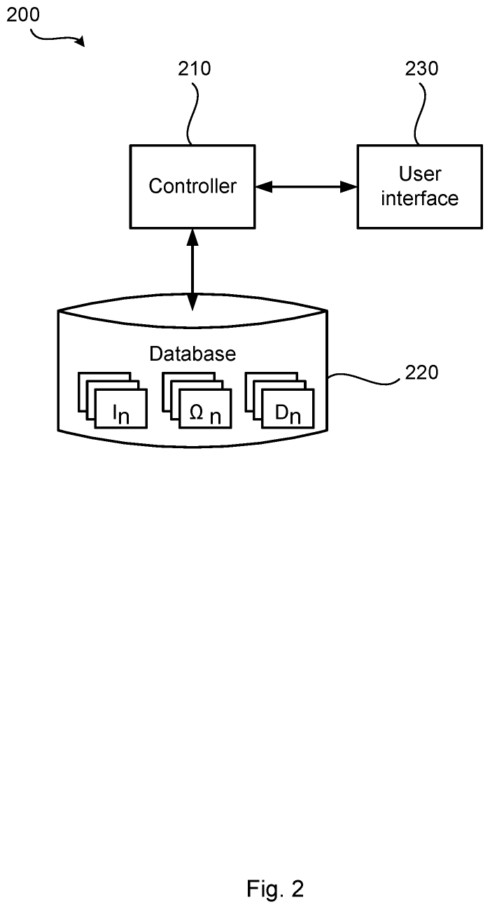

In FIG. 2 is illustrated a system 200 comprising a controller 210, a database 220, and a user interface 230. The database 220 stores N panoramic images Iₙ, 3D point clouds Ωₙ, and depth maps Dₙ. The controller 210 is configured to interact with the user interface 230 and with the database 220.

In general terms, the controller 210 is configured to facilitate improved 3D measurements in a skybox image rendering environment 100 by the use of auxiliary visual information. The auxiliary visual information is provided to the user interface 230 together with the panoramic image 110 when the panoramic image 110 is rendered (by being projected to the sides of the cube) in the skybox image rendering environment 100. That auxiliary visual information helps to identify measurable areas in the skybox image rendering environment 100.

The auxiliary visual information is derived from depth maps of the panoramic image 110, but is thus not necessarily identical to the depth maps themselves. Rather, the auxiliary visual information might be regarded as representing reduced depth maps, for example with depth values at edges only. The auxiliary visual information can thereby support the user not only in calculating actual 3D distances, but also by highlighting the measurable areas (that should contain possible start-points and end-points in the 2D pixel domain).

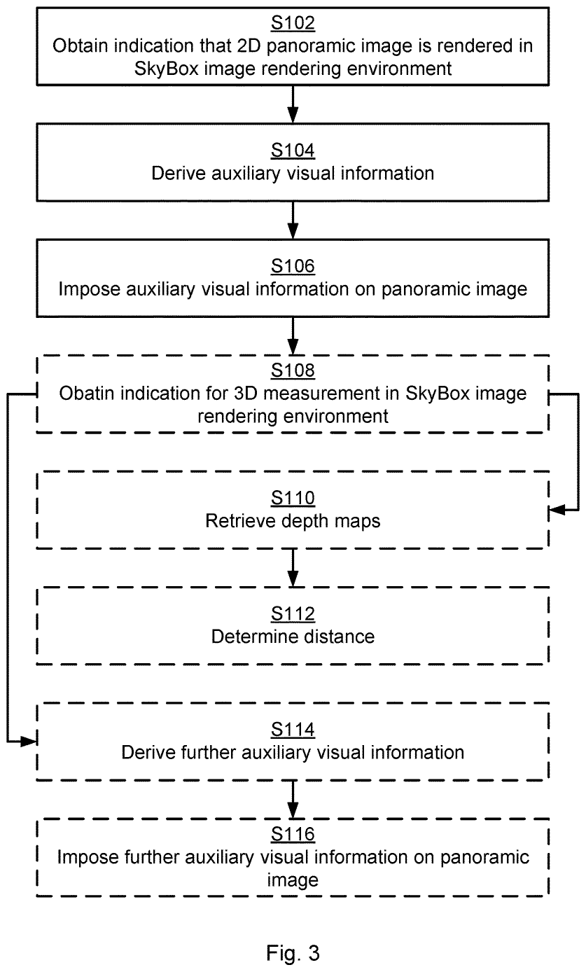

FIG. 3 is a flowchart illustrating embodiments of methods for facilitating 3D measurements in a skybox image rendering environment 100. The methods are performed by the controller 210. The methods are advantageously provided as computer programs 920.

S102: The controller 210 obtains an indication that a 2D panoramic image 110 is rendered in the skybox image rendering environment 100 of a reconstructed 3D environment.

S104: The controller 210 derives auxiliary visual information for the panoramic image 110 from depth maps of the panoramic image 110. The auxiliary visual information identifies 3D measurable areas in the skybox image rendering environment 100.

S106: The controller 210 imposes the auxiliary visual information on the panoramic image 110 as rendered in the skybox image rendering environment 100.

In this respect, there could be different ways in which the auxiliary visual information is imposed on the panoramic image 110. In some examples, there is some virtual spacing between the auxiliary visual information and the panoramic image 110 as the panoramic image 110 is rendered in the skybox image rendering environment 100. In some examples, the auxiliary visual information is imposed to float in front of the panoramic image 110 as the panoramic image 110 is rendered in the skybox image rendering environment 100. In some examples, the auxiliary visual information is imposed by being rendered as a semi-transparent image placed in front of panoramic image 110 as the panoramic image 110 is rendered in the skybox image rendering environment 100. In some examples, the auxiliary visual information is imposed directly on the panoramic image 110 as the panoramic image 110 is rendered in the skybox image rendering environment 100. In some examples, there is some virtual spacing between the auxiliary visual information and the panoramic image 110 as the panoramic image 110 is rendered in the skybox image rendering environment 100.

Embodiments relating to further details of facilitating 3D measurements in a skybox image rendering environment 100 as performed by the controller 210, 700, 800 will now be disclosed with continued reference to FIG. 3.

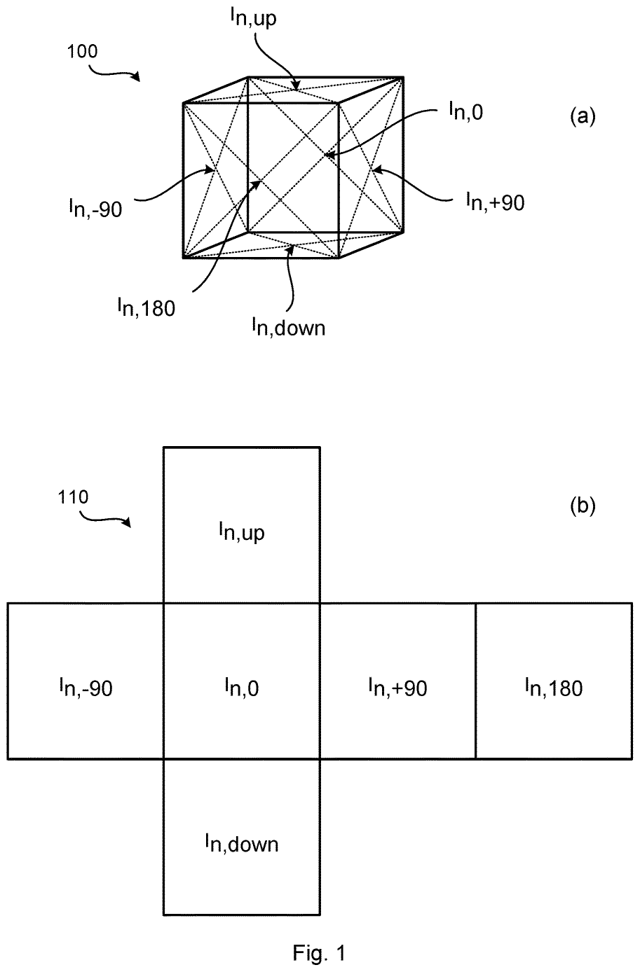

As disclosed above with reference to FIG. 1, one individual image I_{n,s}={I_{n,-90}, I_{n,0}, I_{n,+90}, I_{n,360}, I_{n,up}, I_{n,down}} of a 2D panoramic image 110 can be rendered on each side of the skybox. Each such individual image can then have its own depth map. That is, in some embodiments, the panoramic image 110 is composed of a set of individual images I_{n,s}={I_{n,-90}, I_{n,0}, I_{n,+90}, I_{n,360}, I_{n,up}, I_{n,down}}, with one individual image per each side in the skybox image rendering environment 100, with one depth map per each individual image.

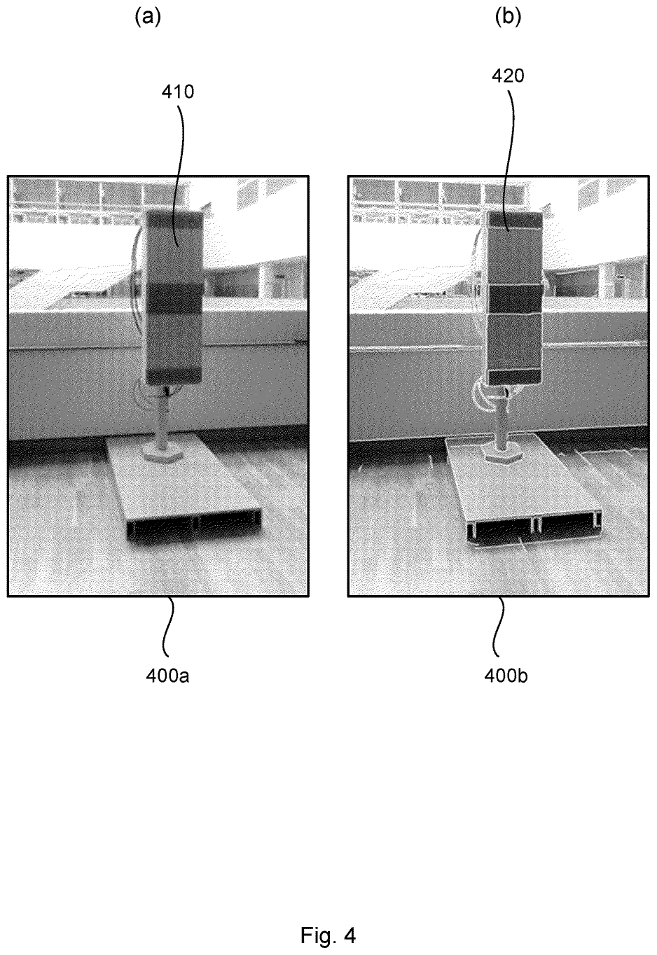

As noted above, the auxiliary visual information might be regarded as representing reduced depth maps, for example with depth values at edges only. Therefore, the depth maps from which the auxiliary visual information is derived can be reduced depth maps. In some examples, such reduced depth maps are depth maps with depth values lying only on locations in the panoramic image 110 that correspond to edges. Particularly, according to some embodiments, the depth map comprises depth information only of 3D measurable areas corresponding to edges 420 depicted in the panoramic image 110. Reference is here made to FIG. 4. In FIG. 4(a) is show an example image 400a depicting a scene with objects, with one object identified at reference numeral 410. In FIG. 4(b) is shown an example image 400b depicting the same scene (and thus the same objects) as in FIG. 4(a) and where auxiliary visual information has been imposed only at the edges of the objects. Hence, in some embodiments, the auxiliary visual information is imposed as visual information on the edges 420.

There could be different types of edges. In some non-limiting examples, the edges 420 occur around objects 410 (such as around furniture or other types of objects) or at intersection between surfaces (such as between two walls or between a wall and a ceiling). That is, in some embodiments, the edges 420 represent perimeters, or parts thereof, of objects 410 depicted in the panoramic image 110, and/or represent intersections between surfaces depicted in the panoramic image 110.

In general terms, with such types of edges 420, the edges 420 can be calculated as discontinues both in the visual image domain (e.g., in the panoramic image 110 itself) and in the depth map. That is, in some examples, the edges 420 represent discontinuities in the depth map.

As discloses above, the auxiliary visual information can support the user by highlighting measurable areas that should contain possible start-points and end-points in the 2D pixel domain. Therefore, in some embodiments, the 3D measurable areas define all possible start-points M₁ and end-points M₂ for 3D measurements in the panoramic image 110.

As further discloses above, the auxiliary visual information can support the user in calculating actual 3D distance. In this respect, in order for a 3D measurement to be performed, the user indicates a start-point and an end-point on side images I_{n,s1}, I_{n,s2} of the skybox. In particular, in some embodiments, the method further comprises step S108.

S108: The controller 210 obtains an indication for a 3D measurement to be made in the skybox image rendering environment 100. The 3D measurement extends between a start-point M₁ and an end-point M₂ in the panoramic image 110.

In case the depth maps for the start-point and the end-point are available, also the associated reduced depth maps D_{1,e} and D_{2,e} are retrieved. In particular, in some embodiments, the method further comprises step S110.

S110: The controller 210 retrieves a first depth map corresponding to the start-point M₁ in the panoramic image 110 and a second depth map corresponding to the end-point M₂ in the panoramic image 110.

It is here noted that in case both the start-point and the end-points are on the same individual image, then only the depth map for that individual image needs to be retrieved in S110. Further, it might be possible to retrieve either the complete depth maps (to which the start-point and the end-point belong), or only the parts of the depth maps that the start-point and the end-point directly corresponds to; this might even be a single depth value (one for the start-point and one for the end-point, or a single pixel in the depth map).

Upon having retrieved the necessary depth map (or depth maps), the distance between the start-point and the end-point can then be calculated. In particular, in some embodiments, the method further comprises step S112.

S112: The controller 210 determines a distance dist_{M} between the start-point M₁ and the end-point M₂ as a function of the first depth map and the second depth map.

In some examples it is, based on the indication for a 3D measurement as obtained in S108 not be possible to determine the distance dist_{M} from the information at hand. In this respects, further auxiliary visual information might be provided that identifies alternative angles, or directions, from which the object of interest is measurable. Such angles, or directions, might identify another skybox. Hence, in some examples, the skybox image rendering environment 100 is a first skybox image rendering environment 100, and the reconstructed 3D environment is composed of at least one further skybox image rendering environment 100. In some embodiments, the method then further comprises steps S114 and S116.

S114: The controller 210 derives further auxiliary visual information for the panoramic image 110. The further auxiliary visual information indicates in which other skybox image rendering environment 100 in the reconstructed 3D environment the 3D measurement is possible.

S116: The controller 210 imposes the further auxiliary visual information on the panoramic image 110 as rendered in the skybox image rendering environment 100.

Once the user has entered another skybox image rendering environment 100 in the reconstructed 3D environment where the 3D measurement is possible, then the user can indicate a (possibly new) start-point and an (possibly new) end-point on side images of the new skybox, where step S108 thus is entered but for the new skybox.

Examples where the herein disclosed embodiments can be used in the context of a user navigating, and intends to make 3D measurements in, a skybox image rendering environment 100 will be disclosed next.

Assume first that the user is navigating in the skybox image rendering environment 100. The controller is then assumed to have entered navigation mode.

The user is enabled to explore the reconstructed 3D environment, by jumping from one Skybox to another, as needed. In this case, when the user makes an attempt to navigate to the n:th skybox, the set of images Iₙ that should be projected on the sides of the n:th skybox are retrieved to form a 2D panoramic image. Rendering is performed and the resulting scene is displayed to the user on the user interface 230.

Assume that the user intends to make 3D measurements in the skybox image rendering environment 100 in the n:th skybox. The controller is then assumed to have entered measurement mode.

A reduced depth map, D_{n,e}, that is associated with the panoramic image Iₙ for the current skybox is retrieved.

Auxiliary visual information is imposed, for example in terms of highlighted edges, on the panoramic image 110 to give an indication to the user of 3D measurable areas in the skybox image rendering environment 100. Location of edges are readily available from the received D_{n,e}.

Hence, whilst some areas are measurable, there could be some areas where 3D measurements are not possible (e.g., because of missing edges). Therefore, the user might not be able to make the desired 3D measurements of a given object in the n:th skybox and therefore needs to move to another skybox to view the given object from another angle, and where the 3D measurements might be possible. Further auxiliary visual information might therefore be imposed on the panoramic image 110 to give an indication to the user of other skybox image rendering environments 100 (say the m:th skybox), in which 3D measurements are possible.

The user might then jump from the n:th skybox to the m:th skybox for performing the 3D measurements.

A new set of images Iₘ that should be projected on the sides of the m:th skybox are therefore retrieved to form a new 2D panoramic image. Rendering is performed and the resulting scene is displayed to the user on the user interface 230.

A new reduced depth map, D_{m,e}, that is associated with the new panoramic image Iₘ for the m:th skybox is retrieved.

Auxiliary visual information is imposed, for example in terms of highlighted edges, on the new panoramic image 110 to give an indication to the user of 3D measurable areas in the m:th skybox image rendering environment 100. Location of edges are readily available from the received D_{m,e}.

In addition, to assist the user to navigate, yet further auxiliary visual information might be imposed on the panoramic image 110 to give an indication to the user of which other skyboxes the user has already visited (the n:th skybox in the present example). In this way, if the user continues to move to different skyboxes (while in measurement mode), all previously visited sweep positions, and thus skyboxes, can be indicated, possible with a unique marker per visited skybox. This allow the user to keep track of any previously visited positions, as the user is in a search for a new position, or angle, from which the object of interest is measurable.

Once the 3D measurement has been performed, or when the user aborts the 3D measurement for other reasons, the controller leaves the measurement mode and all auxiliary visual information is removed.

Aspects of how depth maps can be generated from 3D point clouds (i.e., how the mapping Ω→Dₙ can be realized) will be disclosed next.

In general terms, one 3D point cloud Ωₙ, as generated from the n:th scan, or sweep, for each panoramic image (n=1 . . . N for N sweeps) can be kept in the database 220 in addition to the set of images Iₙ for each panoramic image. Further, the database 220 might also hold the sensor pose Pₙ (i.e., the position and orientation of the scanning device) for each sweep.

Re-projection of the 3D point cloud Ωₙ on the panoramic image Iₙ can then be achieved with the help of the sensor pose Pₙ. This projection results in either one depth map for the entire panoramic image or one depth maps being associated with each individual image of the panoramic image (with one depth map for each of the sides of the cube).

Aspects of re-projection from a 3D point cloud to the 2D image plane will be disclosed next.

The sensor pose P in the 3D point cloud coordinate system can be defined by its position (Xₚ, Yₚ, Zₚ) and orientation angles (ω, φ,τ). With the rotation matrix R defined as follows:

$$R = ( \begin{matrix}1 & 0 & 0 \\ 0 & cos ( ω ) & - sin ( ω ) \\ 0 & sin ( ω ) & cos ( ω )\end{matrix} ) ( \begin{matrix}cos ( φ ) & 0 & sin ( φ ) \\ 0 & 1 & 0 \\ - sin ( φ ) & 0 & cos ( φ )\end{matrix} ) ( \begin{matrix}cos ( τ ) & - sin ( τ ) & 0 \\ sin ( τ ) & cos ( τ ) & 0 \\ 0 & 0 & 1\end{matrix} ) ,$$

and the translation vector n defined as follows:

$$n = [ \begin{matrix}{X}_{P} \\ {Y}_{P} \\ {Z}_{P}\end{matrix} ] ,$$

the pose P in homogenous coordinates can be defined as:

$$P = [ \begin{matrix}R & n \\ 0 & 1\end{matrix} ] .$$

Re-projection of a point m=[Xₖ, Yₖ, Zₖ] from the 3D point cloud Ω to the camera coordinate system corresponding to pose P is then given by:

$${m}^{*} = {P}^{T} m .$$

Next,

$${m}^{*} = [ {X}_{k}^{*} , {Y}_{k}^{*} , {Z}_{k}^{*} ]$$

is converted into 2D image coordinates (i.e., pixel coordinates) as:

$$[ {u}^{*} , {v}^{*} ] = [ - f \frac{{X}_{x}^{*}}{{X}_{z}^{*}} , - f \frac{{X}_{y}^{*}}{{X}_{z}^{*}} ] + [ {s}_{x} , {s}_{y} ] ,$$

where intrinsic camera parameters, in terms of focal length f and principal point [sₓ, s_{y}], are used.

Then, the depth value d stored at pixel position [u*, v*] is the Euclidian distance between the sensor position n and the point m. That is:

$$d = \sqrt{{( {X}_{P} - {X}_{k} )}^{2} + {( {Y}_{P} - {Y}_{k} )}^{2} + {( {Z}_{P} - {Z}_{k} )}^{2}} .$$

Repeating this for all pixels for a given image results in a depth map associated with the given image on the skybox.

Aspects of how the reduced depth maps can be calculated (i.e., how the mapping Dₙ→D_{n,e} can be realized) will be disclosed next.

The produced depth maps can be used to generated reduced depth maps D_{n,e} with depth values lying only on locations corresponding to edges. Edges might be calculated as discontinuities, both in the visual domain as well as in the depth maps. In some examples, edges therefore refer to the union of edges detected in both these domains (i.e., both in the visual domain and in the depth maps). Techniques available in the field of image processing for segmentation, edge detection, or contour detection can be used for this purpose.

Aspects of how a 3D measurement, given the start-point and end point in the 2D pixel image plane, can be made will be disclosed next.

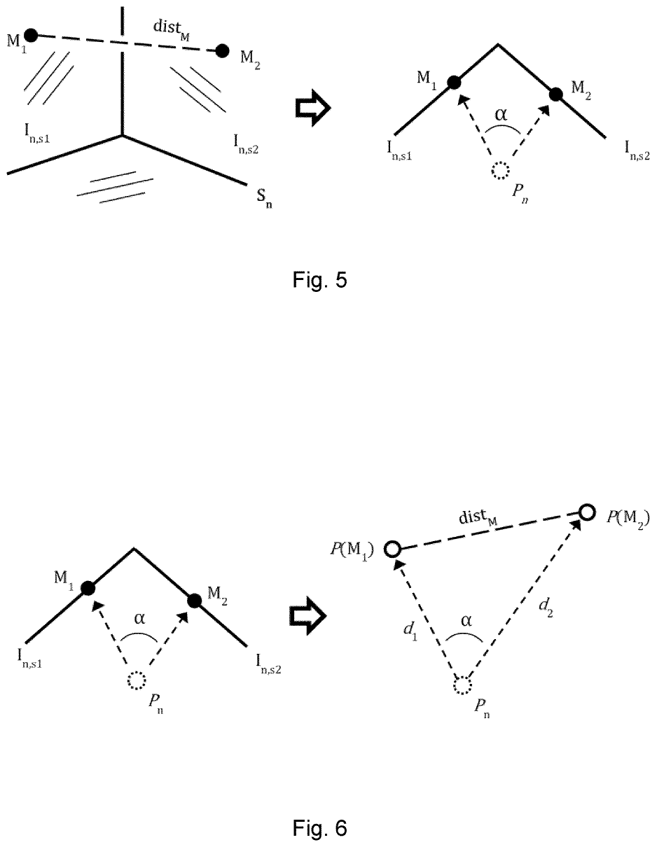

The 3D measurement process is started when the user indicates a start-point and an end-point for the 3D measurement. The skybox is shown to the user in a virtual 3D environment, and therefore the user selects the start-point and the end-point on the skybox surface. The process is illustrated in FIG. 5 and in FIG. 6, where a user is assumed to indicate a start point start-point M₁ and an end-point M₂ on images I_{1,s1}, I_{n,s2}. The distance between the start-point M₁ and the end-point M₂ is denoted dist_{M}. As illustrated in FIGS. 5 and 6, the start-point and the end point do not need to be on the same image, but they do need to be in the same skybox.

The associated reduced depth maps D_{1,e} and D_{2,e} are therefore retrieved.

First, an angle α is calculated between the user-indicated start and end point on the skybox, using the skybox centre as the apex (see, FIG. 5). Specifically, the angle α is calculated between the line l_{centre,start} connecting the skybox centre Pₙ to the start-point M₁, and the line l_{centre,end} connecting the skybox centre Pₙ to the end-point M₂, as follows:

$$α = {cos}^{- 1} ( \frac{{l}_{centre , start} \cdot {l}_{centre , end}}{\vert {l}_{centre , start} \vert \vert {l}_{centre , end} \vert} ) .$$

Next, the distance d₁ between the skybox centre Pₙ and the start-point M₁ and the distance d₂ between the skybox centre Pₙ and the end-point M₂ are read from the reduced depth maps D_{1,e} and D_{2,e}. Since D_{n,e} has the same resolution as I_{n,s}, the user's selection of a point (as a 2D pixel) in I_{n,s} also gives the selection of the appropriate depth value in D_{n,e}. The 3D measurement is then calculated using α and d₁, d₂ as follows:

$${dist}_{M} = \sqrt{{d}_{1}^{2} + {d}_{2}^{2} - 2 {d}_{1} {d}_{2} cos α} .$$

The value of dist_{M} can then be displayed to the user on the user interface 230.

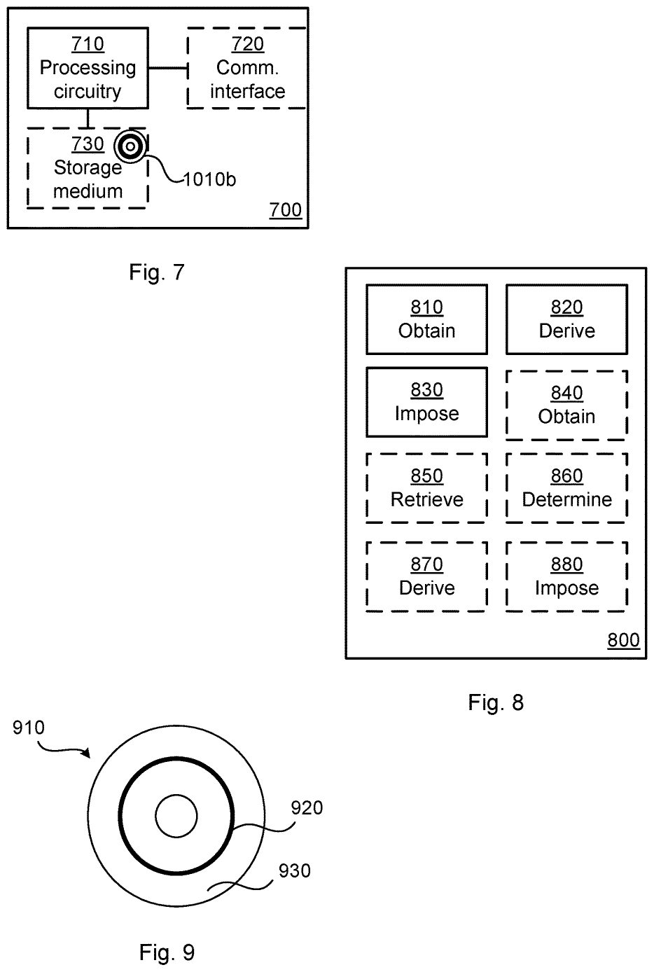

FIG. 7 schematically illustrates, in terms of a number of functional units, the components of a controller 700 according to an embodiment. Processing circuitry 710 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 730. The processing circuitry 710 may further be provided as at least one application specific integrated circuit (ASIC), or field programmable gate array (FPGA).

Particularly, the processing circuitry 710 is configured to cause the controller 700 to perform a set of operations, or steps, as disclosed above. For example, the storage medium 730 may store the set of operations, and the processing circuitry 710 may be configured to retrieve the set of operations from the storage medium 730 to cause the controller 700 to perform the set of operations. The set of operations may be provided as a set of executable instructions.

Thus the processing circuitry 710 is thereby arranged to execute methods as herein disclosed. The storage medium 730 may also comprise persistent storage, which, for example, can be any single one or combination of magnetic memory, optical memory, solid state memory or even remotely mounted memory. The controller 700 may further comprise a communications (comm.) interface 720 at least configured for communications with other entities, functions, nodes, and devices, as in FIG. 2. As such the communications interface 720 may comprise one or more transmitters and receivers, comprising analogue and digital components. The processing circuitry 710 controls the general operation of the controller 700 e.g. by sending data and control signals to the communications interface 720 and the storage medium 730, by receiving data and reports from the communications interface 720, and by retrieving data and instructions from the storage medium 730. Other components, as well as the related functionality, of the controller 700 are omitted in order not to obscure the concepts presented herein.

FIG. 8 schematically illustrates, in terms of a number of functional modules, the components of a controller 800 according to an embodiment. The controller 800 of FIG. 8 comprises a number of functional modules; an obtain module 810 configured to perform step S102, a derive module 820 configured to perform step S104, and an impose module 830 configured to perform step S106. The controller 800 of FIG. 8 may further comprise a number of optional functional modules, such as any of an obtain module 840 configured to perform step S108, a retrieve module 850 configured to perform step S110, a determine module 860 configured to perform step S112, a derive module 870 configured to perform step S114, and an impose module 880 configured to perform step S116.

In general terms, each functional module 810:880 may in one embodiment be implemented only in hardware and in another embodiment with the help of software, i.e., the latter embodiment having computer program instructions stored on the storage medium 730 which when run on the processing circuitry makes the controller 800 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 810:880 may be implemented by the processing circuitry 710, possibly in cooperation with the communications interface 720 and/or the storage medium 730. The processing circuitry 710 may thus be configured to from the storage medium 730 fetch instructions as provided by a functional module 810:880 and to execute these instructions, thereby performing any steps as disclosed herein.

The controller 210, 700, 800 may be provided as a standalone device or as a part of at least one further device. A first portion of the instructions performed by the controller 210, 700, 800 may be executed in a first device, and a second portion of the of the instructions performed by the controller 210, 700, 800 may be executed in a second device; the herein disclosed embodiments are not limited to any particular number of devices on which the instructions performed by the controller 210, 700, 800 may be executed. Hence, the methods according to the herein disclosed embodiments are suitable to be performed by a controller 210, 700, 800 residing in a cloud computational environment. Therefore, although a single processing circuitry 710 is illustrated in FIG. 7 the processing circuitry 710 may be distributed among a plurality of devices, or nodes. The same applies to the functional modules 810:880 of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 710 and thereto operatively coupled entities and devices, such as the communications interface 720 and the storage medium 730, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for facilitating three-dimensional (3D) measurements in a skybox image rendering environment, the method being performed by a controller, the method comprising:
obtaining an indication that a two-dimensional (2D) panoramic image is rendered in the skybox image rendering environment of a reconstructed 3D environment;
deriving auxiliary visual information for the panoramic image from depth maps of the panoramic image, wherein the auxiliary visual information identifies 3D measurable areas in the skybox image rendering environment; and
imposing the auxiliary visual information on the panoramic image as rendered in the skybox image rendering environment.

2. The method of claim 1, wherein the panoramic image is composed of a set of individual images I_{n,s}={I_{n,-90}, I_{n,0}, I_{n,+90}, I_{n,360}, I_{n,up}, I_{n,down}}, with one individual image per each side in the skybox image rendering environment, and wherein there is one depth map per each individual image.

3. The method of claim 1, wherein the depth map comprises depth information only of 3D measurable areas corresponding to edges depicted in the panoramic image.

4. The method of claim 3, wherein the auxiliary visual information is imposed as visual information on said edges.

5. The method of claim 3, wherein the edges represent perimeters, or parts thereof, of objects depicted in the panoramic image, and/or represent intersections between surfaces depicted in the panoramic image.

6. The method of claim 3, wherein the edges represent discontinuities in the depth map.

7. The method of claim 1, wherein the 3D measurable areas define all possible start-points (M₁) and end-points (M₂) for 3D measurements in the panoramic image.

8. The method of claim 1, wherein the method further comprises:
obtaining an indication for a 3D measurement to be made in the skybox image rendering environment, the 3D measurement extending between a start-point (M₁) and an end-point (M₂) in the panoramic image;
retrieving a first depth map corresponding to the start-point (M₁) in the panoramic image and a second depth map corresponding to the end-point (M₂) in the panoramic image; and
determining a distance (dist_{M}) between the start-point (M₁) and the end-point (M₂) as a function of the first depth map and the second depth map.

9. The method of claim 1, wherein the skybox image rendering environment is a first skybox image rendering environment, wherein the reconstructed 3D environment is composed of at least one further skybox image rendering environment, and wherein the method further comprises:
obtaining an indication for a 3D measurement to be made in the skybox image rendering environment, the 3D measurement extending between a start-point (M₁) and an end-point (M₂) in the panoramic image;
deriving further auxiliary visual information for the panoramic image, the further auxiliary visual information indicating in which other skybox image rendering environment in the reconstructed 3D environment the 3D measurement is possible; and
imposing the further auxiliary visual information on the panoramic image as rendered in the skybox image rendering environment.

10. A controller for facilitating three-dimensional (3D) measurements in a skybox image rendering environment, the controller comprising processing circuitry, the processing circuitry being configured to cause the controller to perform a method comprising:
obtaining an indication that a two-dimensional (2D) panoramic image is rendered in the skybox image rendering environment of a reconstructed 3D environment;
deriving auxiliary visual information for the panoramic image from depth maps of the panoramic image, wherein the auxiliary visual information identifies 3D measurable areas in the skybox image rendering environment; and
imposing the auxiliary visual information on the panoramic image as rendered in the skybox image rendering environment.

11. The controller of claim 10, wherein the depth map comprises depth information only of 3D measurable areas corresponding to edges depicted in the panoramic image.

12. The controller of claim 11, wherein the edges represent perimeters, or parts thereof, of objects depicted in the panoramic image, and/or represent intersections between surfaces depicted in the panoramic image.

13. A computer program product (CPP) comprising a non-transitory computer readable storage medium storing a computer program for facilitating three-dimensional (3D) measurements in a skybox image rendering environment, the computer program comprising computer code which, when run on processing circuitry of a controller, causes the controller to perform a method comprising:
obtaining an indication that a two-dimensional, 2D, panoramic image is rendered in the skybox image rendering environment of a reconstructed 3D environment;
deriving auxiliary visual information for the panoramic image from depth maps of the panoramic image, wherein the auxiliary visual information identifies 3D measurable areas in the skybox image rendering environment; and
imposing the auxiliary visual information on the panoramic image as rendered in the skybox image rendering environment.

14. (canceled)

15. The controller of claim 10, wherein the panoramic image is composed of a set of individual images I_{n,s}={I_{n,-90}, I_{n,0}, I_{n,+90}, I_{n,360}, I_{n,up}, I_{n,down}}, with one individual image per each side in the skybox image rendering environment, and wherein there is one depth map per each individual image.

16. The controller of claim 11, wherein the edges represent discontinuities in the depth map.

17. The controller of claim 11, wherein the auxiliary visual information is imposed as visual information on said edges.

18. The controller of claim 10, wherein the 3D measurable areas define all possible start-points (M₁) and end-points (M₂) for 3D measurements in the panoramic image.

19. The controller of claim 10, wherein the method further comprises:
obtaining an indication for a 3D measurement to be made in the skybox image rendering environment, the 3D measurement extending between a start-point (M₁) and an end-point (M₂) in the panoramic image;
retrieving a first depth map corresponding to the start-point (M₁) in the panoramic image and a second depth map corresponding to the end-point (M₂) in the panoramic image; and
determining a distance (dist_{M}) between the start-point (M₁) and the end-point (M₂) as a function of the first depth map and the second depth map.

20. The controller of claim 10, wherein the skybox image rendering environment is a first skybox image rendering environment, wherein the reconstructed 3D environment is composed of at least one further skybox image rendering environment, and wherein the method further comprises:
obtaining an indication for a 3D measurement to be made in the skybox image rendering environment, the 3D measurement extending between a start-point (M₁) and an end-point (M₂) in the panoramic image;
deriving further auxiliary visual information for the panoramic image, the further auxiliary visual information indicating in which other skybox image rendering environment in the reconstructed 3D environment the 3D measurement is possible; and
imposing the further auxiliary visual information on the panoramic image as rendered in the skybox image rendering environment.
